(19) United States
(12) Patent Application Publication
(10) Pub. No.: US 2008/0061704 A1
(43) Pub. Date: Mar. 13, 2008

(54) Plasma Display Device

(76) Inventors: Atsushi Yokoyama, Kawasaki (JP); Yoshikazu Kanazawa, Kawasaki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/751,176

(22) Filed: May 21, 2007

(30) Foreign Application Priority Data
Sep. 12, 2006 (JP) 2006-247127

(51) Int. Cl. G09G 3/10

(52) U.S. Cl. 315/169.4

(57) ABSTRACT

A disclosed plasma display device is provided with a capacitive load driving circuit configured to drive a capacitive load. A first terminal of the capacitive load is connected to an output terminal of the capacitive load driving circuit, and a driver power supply is connected through a series connection of a power distributing unit and a driver element to the output terminal of the capacitive load driving circuit. A diode is connected in parallel to the power distributing unit.

### BACKGROUND OF THE INVENTION

1. Field of the Invention

The present invention relates to plasma display devices, and more particularly to a plasma display device provided with a capacitive load driving circuit for driving a capacitive load.

2. Description of the Related Art

In recent years and continuing, research and development are being conducted for plasma display panels (PDP) and electroluminescence (EL) panels. Of particular note is that PDPs can display large screens at high speed with improved display qualities. Therefore, PDPs are attracting attention as alternative display devices to CRT panels.

However, the problem with such PDPs is that they consume a large amount of power, because they display images by driving display cells, which are capacitive loads (and wiring capacities, etc.), with high-voltage pulse signals.

One approach is to provide a circuit that can drive capacitive loads (display cells) by consuming a small amount of power. However, the problem with such a driving circuit is that they emit heat. What is needed is a capacitive load driving circuit that does not emit much heat.

FIG. 1 is a block diagram of a plasma display device. As shown in FIG. 1, the plasma display device includes a display panel 101, an anode (address) driving circuit 102, a cathode (Y) driving circuit 103, a sub-anode driving circuit 104, a control circuit 105, an X driving circuit 106, and discharge cells 107.

The following primarily describes an address driving circuit (address drive IC) in a plasma display device. A capacitive load driving circuit according to an embodiment of the present invention can be applied not only as an address driving circuit in a plasma display device but also as a circuit for driving capacitive loads (discharge cells) such as an X driving circuit or a Y driving circuit.

FIG. 1 illustrates both a direct-current type (DC type) plasma display device and an alternating-current type (AC type) plasma display device. The DC type plasma display device includes the anode driving circuit 102, the cathode driving circuit 103, and the sub-anode driving circuit 104. The AC type plasma display device includes the address driving circuit 102, the Y driving circuit 103, and the X driving circuit 106. The display panel 101 and the control circuit 105 are provided in both the AC type and the DC type.

The display panel 101 (plasma display panel: PDP) is largely classified as a DC type PDP or an AC type PDP. The DC PDPs have the characteristic that matrix discharge electrodes are exposed in each of the discharge cells 107 and the electric field control of the discharge space in the cell is easy. Furthermore, in a DC type PDP, electrode polarities are specified as anode A1-Ad and cathode K1-KL, and therefore, the discharge emission status can be easily optimized. Furthermore, images can be displayed with low voltage and at high speed by combining a main discharge between anodes/cathodes and a preliminary discharge using sub-anode electrodes SA1-SA (d/2) shared between adjacent anode electrodes.

As described above, a driving unit of the DC type PDP includes the three driving circuits, i.e., the anode driving circuit 102, the cathode driving circuit 103, and the sub-anode driving circuit 104, and also includes the control circuit 105 for controlling these driving circuits.

Meanwhile, AC PDPs have the characteristic that the matrix discharge electrodes are covered and protected with a dielectric layer, which reduces electrode degradation due to discharge and achieves a longer service life. Furthermore, there is a commercially-implemented three-electrode panel model (three-electrode surface-discharge AC-type PDP) having a simple structure. Specifically, a front panel with X electrodes and Y electrodes formed thereon in a horizontal line direction and a back panel with address electrodes in the vertical column direction are simply laminated together on top of each other in the vertical direction. This facilitates the construction of a higher-resolution display.

As described above, a driving unit of the AC type PDP includes the three driving circuits, i.e., the address driving circuit 102, the Y driving circuit 103, and the X driving circuit 106, and the control circuit 105 for controlling these driving circuits. The address driving circuit 102 selects a light emitting cell in the column direction according to video data. The Y driving circuit 103 selectively scans the lines. The X driving circuit 106 simultaneously applies sustain pulses for main light emittance onto all lines.

Driving terminals of the electrodes are insulated from all circuit grounds in terms of the direct current, except for dummy electrodes at edges of the panel. Accordingly, the capacitive impedance becomes the dominant load of the driving circuit. Incidentally, in a prior art technique for achieving power reduction in a pulsed capacitive-load driving circuit, it is known to provide a power recovery circuit that utilizes a phenomenon of resonance for energy transfer between load capacitance and inductance. One specific example of the power recovery technique suitable for a driving circuit where the load capacitance varies greatly for driving each individual load electrode by a mutually independent voltage in accordance with a display image, as in an address electrode driving circuit, is the low power driving circuit disclosed in Patent Document 1.

FIG. 2 is a block diagram of an example of a driving circuit of a conventional plasma display device, which is the low power driving circuit disclosed in Patent Document 1. As shown in FIG. 2, the driving circuit includes a power recovery circuit 110, an output terminal 111 of the power recovery circuit 110, an address driving circuit (address drive IC) 120, a power supply terminal 121 of the address drive IC 120, output circuits 122 inside the address drive IC 120 (hereinafter, “in-drive IC output circuit 122”), and an output terminal 123 inside the address drive IC 120. CL denotes capacitive loads including discharge cells and wiring capacities.

The conventional circuit shown in FIG. 2 suppresses power consumption by using the power recovery circuit 110 provided with an inductance for resonance (resonance inductance) to drive the power supply terminal 121 of the address drive IC 120. The power recovery circuit 110 outputs the regular predetermined address driving voltage at a timing for generating address discharge at an address electrode of the plasma display panel. Before the switching status of the in-drive IC output circuit 122 changes over, the power recovery circuit 110 decreases the voltage level of the power supply terminal 121 to ground level.

At this point, resonance occurs between the resonance inductance inside the power recovery circuit 110 and the composite capacitive loads (e.g., maximum: n×CL) of an arbitrary number of address electrodes being driven at high level (e.g., maximum: n electrodes). This greatly suppresses the power consumption of output elements of the in-drive IC output circuit 122.

In the conventional capacitive load driving circuit, the power supply voltage of the address drive IC is constant. The changed amount of accumulated energy present in the capacitive loads CL around the timing of switching the discharged cells is entirely consumed at the resistive impedance in the charge/discharge current path. When the power recovery circuit 110 is used, the amount of the position energy accumulated in the capacitive loads determined based on the midpoint potential of the address driving voltage acting as the resonance center of the output voltage is maintained via the resonance inductance inside the recovery circuit.

When the power supply voltage is at ground level, the switching status of the in-drive IC output circuit 122 is changed over. Subsequently, the power supply voltage of the address drive IC is increased once again to the regular predetermined driving voltage after resonance. Accordingly, power consumption is suppressed.

FIG. 3 is a block diagram of a capacitive load driving circuit in a conventional plasma display device. As shown in FIG. 3, the capacitive load driving circuit includes a driver power supply 1, a resistance element 21, an address drive IC 3, a reference potential point (ground point) 4, a capacitive load (CL) 5, driver elements 6, 7, a power supply terminal 8 of the address drive IC, a reference potential terminal (ground terminal) 9, and an output terminal 10 of the address drive IC.

The resistance element 21 is provided between the driver power supply 1 and the high-potential power supply terminal 8 of the address drive IC 3. The resistance element 21 has a resistive impedance that is higher than one tenth of a resistive impedance of the driver element 6 during conduction (resistance component of impedance during conduction). Power consumption of the address drive IC 3 can be suppressed by distributing, to the resistance element 21, approximately one tenth or more of the power consumption of the driver element 6 while driving the loads.

Patent Document 1: Japanese Laid-Open Patent Application No. 2005-175044

For example, an n channel MOSFET (Metal Oxide Semiconductor Field Effect Transistor: hereinafter, “MOS transistor”) is employed as each of the driver elements 6, 7 of the capacitive load driving circuit.

The MOS transistors acting as the driver elements 6, 7 have parasitic diodes as indicated with dashed lines. Incidentally, the other terminal of the capacitive load (CL) 5 formed by discharge cells, etc., is connected to an X electrode and a Y electrode. Accordingly, when the driver elements 6, 7 are turned off and voltage is applied to the X electrode and/or the Y electrode, the potential of the output terminal 10 becomes higher than the potential of the power supply terminal 8. In such a case, as the resistance element 21 is provided, the voltage change of the X electrode and/or the Y electrode acts as a surge applied through the drain and the source of the driver element 6. As a result, the driver element 6 may break down due to high voltage.

### SUMMARY OF THE INVENTION

The present invention provides a plasma display device in which one or more of the above-described disadvantages are eliminated.

A preferred embodiment of the present invention provides a plasma display device capable of preventing a driver element from breaking down due to high voltage as a result of a voltage change at a terminal of a capacitive load.

An embodiment of the present invention provides a plasma display device provided with a capacitive load driving circuit configured to drive a capacitive load, wherein a first terminal of the capacitive load is connected to an output terminal of the capacitive load driving circuit, and a driver power supply is connected through a series connection of a power distributing unit and a driver element to the output terminal of the capacitive load driving circuit, and a diode being connected in parallel to the power distributing unit.

According to one embodiment of the present invention, a plasma display device is provided, which is capable of preventing a driver element from breaking down due to high voltage as a result of a voltage change at a terminal of a capacitive load.

### BRIEF DESCRIPTION OF THE DRAWINGS

Other objects, features and advantages of the present invention will become more apparent from the following detailed description when read in conjunction with the accompanying drawings, in which:

FIG. 1 is a block diagram of an overall configuration of a plasma display device;

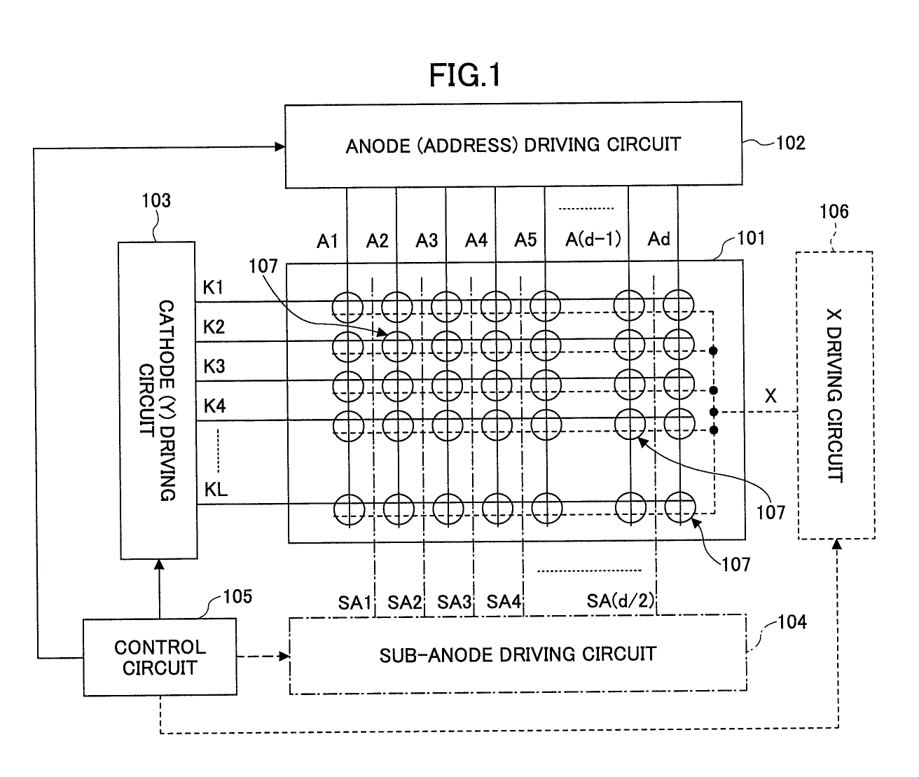

FIG. 2 is a block diagram of an example of a driving circuit of a conventional plasma display device;

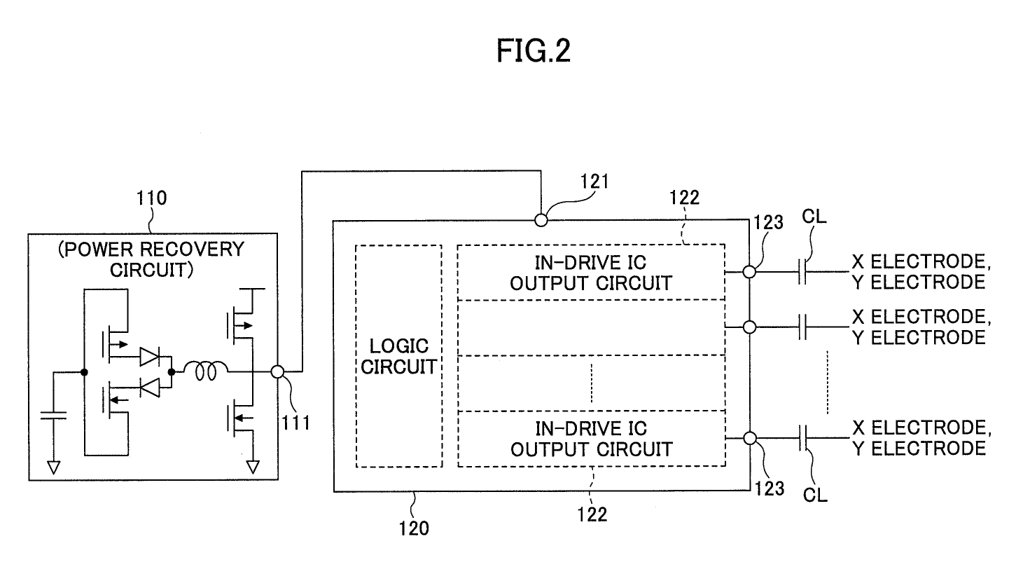

FIG. 3 is a circuit diagram of a capacitive load driving circuit in a conventional plasma display device;

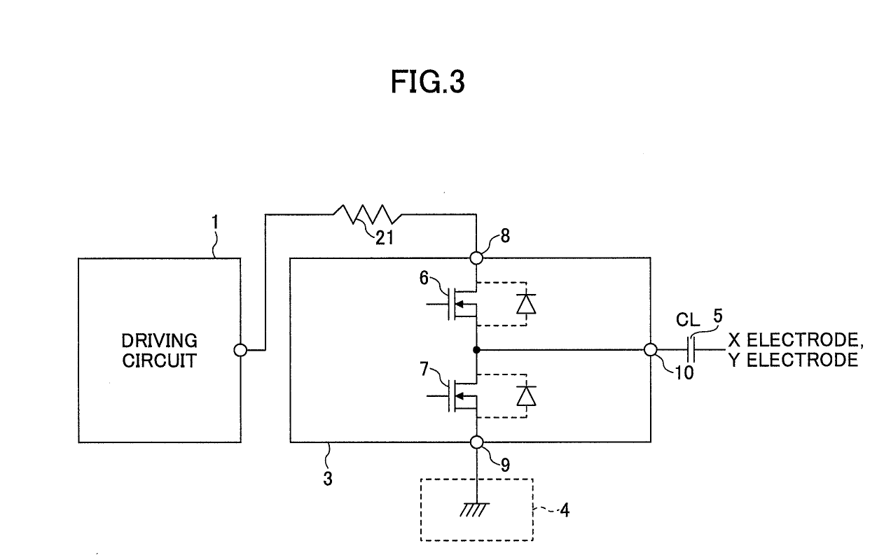

FIG. 4 is a circuit diagram of a capacitive load driving circuit of a plasma display device according to an embodiment of the present invention;

FIGS. 5A-5C are voltage waveform diagrams for describing an embodiment of the present invention;

FIG. 6 is a circuit diagram of a totem pole type address drive IC of a capacitive load driving circuit according to an embodiment of the present invention;

FIG. 7 is a sectional schematic diagram of a three-electrode surface-discharge AC-PDP;

FIG. 8 is a block diagram of relevant parts of a plasma display device;

FIG. 9 illustrates an example of a basic operation of the driving circuit shown in FIG. 8;

FIG. 10 illustrates a typical address voltage waveform applied to address electrodes and a typical scanning voltage waveform applied to the Y electrodes;

FIG. 11 illustrates a method of displaying gradation shades by a sub frame method; and

FIG. 12 is a circuit diagram of an example of the scan driver IC.

### DETAILED DESCRIPTION OF THE PREFERRED EMBODIMENTS

A description is given, with reference to the accompanying drawings, of an embodiment of the present invention.

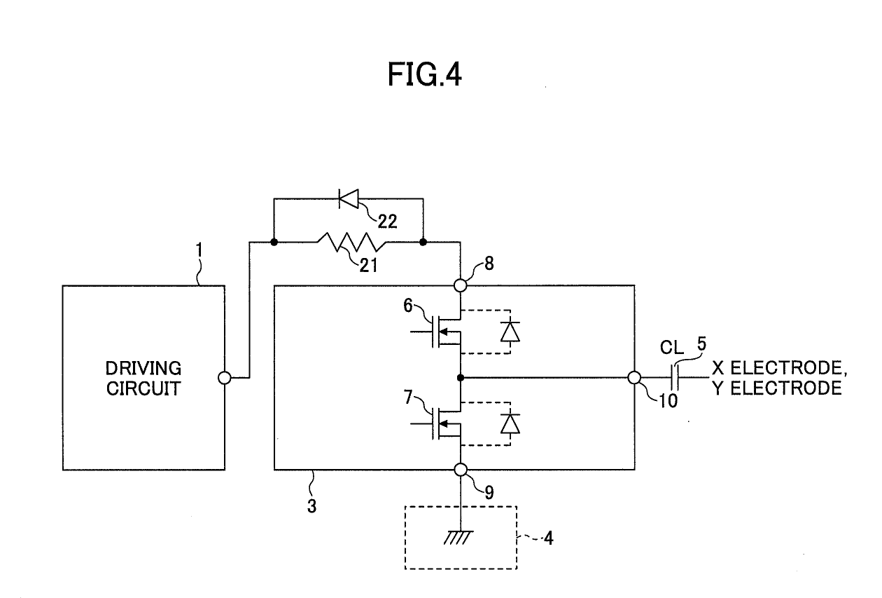

FIG. 4 is a block diagram of a capacitive load driving circuit of a plasma display device according to an embodiment of the present invention. As shown in FIG. 4, the capacitive load driving circuit includes a driver power supply 1, a resistance element 21, a diode 22, an address drive IC 3, a reference potential point (ground point) 4, a capacitive load (CL) 5, driver elements 6, 7, a power supply terminal 8 of the address drive IC, a reference potential terminal (ground terminal) 9, and an output terminal 10 of the address drive IC. An n channel MOS transistor is employed as each of the driver elements 6, 7, one terminal of the capacitive load (CL) 5 formed by discharge cells, etc., is connected to the output terminal 10, and another terminal of the capacitive load (CL) 5 is connected to an X electrode and a Y electrode.

The resistance element 21 is provided between the driver power supply 1 and the high-potential power supply terminal 8 of the address drive IC 3. The resistance element 21 has a resistive impedance that is higher than one tenth of a resistive impedance of the driver element 6 during conduction (resistance component of impedance during conduction). Between both terminals of the resistance element 21, the diode 22 is connected in parallel with the resistance element 21. The cathode of the diode 22 is on the side of the driver power supply 1 and the anode of the diode 22 is on the side of the power supply terminal 8.

When the driver elements 6, 7 are turned off and voltage is applied to the X electrode and/or the Y electrode connected to the other terminal of the capacitive load (CL) 5, and the potential of the output terminal 10 becomes higher than the potential of the power supply terminal 8, the diode 22 provided in parallel with the resistance element 21 turns on. Therefore, the voltage change of the X electrode and/or the Y electrode flows to the driver power supply 1 and is absorbed by the driver power supply 1.

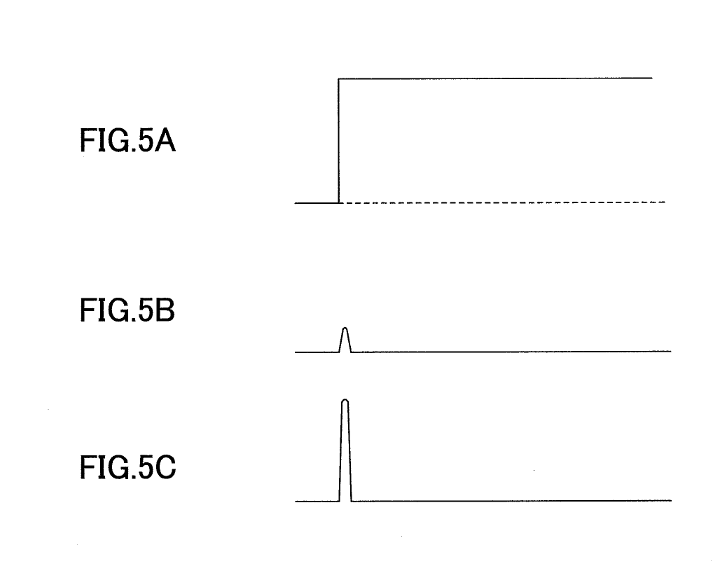

FIG. 5A illustrates the step-shaped voltage waveform applied to the X electrode and/or the Y electrode. FIG. 5B illustrates the voltage waveform between the drain and the source of the MOS transistor acting as the driver element 6 in a case where the diode 22 is provided. FIG. 5C illustrates the voltage waveform between the drain and the source of the MOS transistor acting as the driver element 6 in a case where the diode 22 is not provided.

As described above, when there is a voltage change at the X electrode and/or the Y electrode, the diode 22 switches on so that the voltage applied between the drain and the source of the MOS transistor acting as the driver element 6 is reduced. Accordingly, by providing the diode 22, it is possible to prevent the MOS transistor acting as the driver element 6 from breaking down due to high voltage.

Even if the resistance element 21 in the above embodiment is a constant-current source, the current effective value flowing to the driver element 6 can be minimized under the same driving conditions as described above. Similarly to the above embodiment, by providing the diode 22 in parallel with the constant-current source, with the cathode of the diode 22 on the side of the driver power supply 1 and the anode of the diode 22 on the side of the power supply terminal 8, it is possible to prevent the MOS transistor acting as the driver element 6 from breaking down due to high voltage.

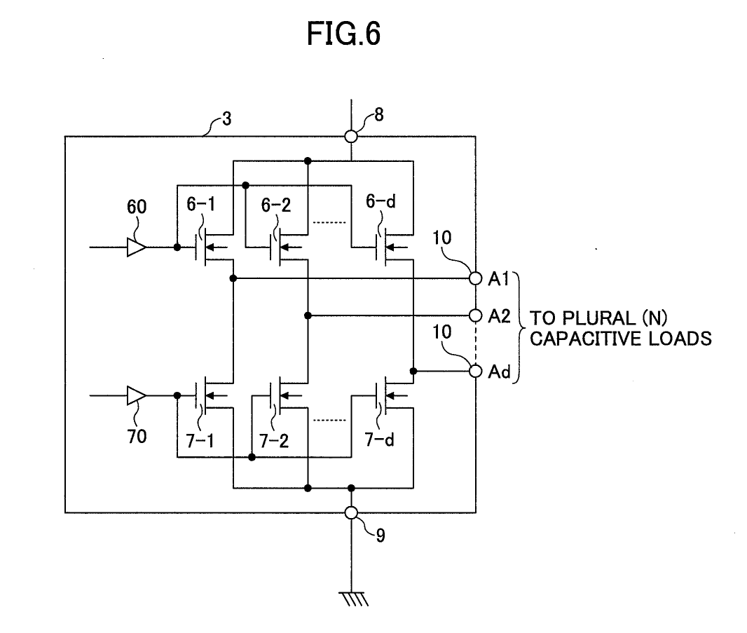

FIG. 6 is a circuit diagram of a totem pole type address drive IC of a capacitive load driving circuit according to an embodiment of the present invention. The address drive IC 3 according to this embodiment is for driving d address electrodes (A1-Ad) in a plasma display device. Driver elements 6-1-6-d on the pull-up side and driver elements 7-1-7-d on the pull-down side both configure totem pole type n channel MOS transistors. The driver elements on the pull-up side and the pull-down side are driven by drive stages 60 and 70, respectively.

By configuring the drive circuit 3 as a totem pole type circuit, it is possible to employ only n channel MOS transistors that have higher current capacities than p channel MOS transistors. Accordingly, the chip area can be reduced, so that the driving circuit (IC) can be constructed at low cost. In another example, p channel MOS transistors can be employed as the driver elements 7-1-7-d on the pull-down side so as to form a CMOS configuration. Accordingly, the driving power of the driver elements on the pull-up side can be reduced, so that the driving voltage rises and falls in a symmetrical manner and operations are accelerated.

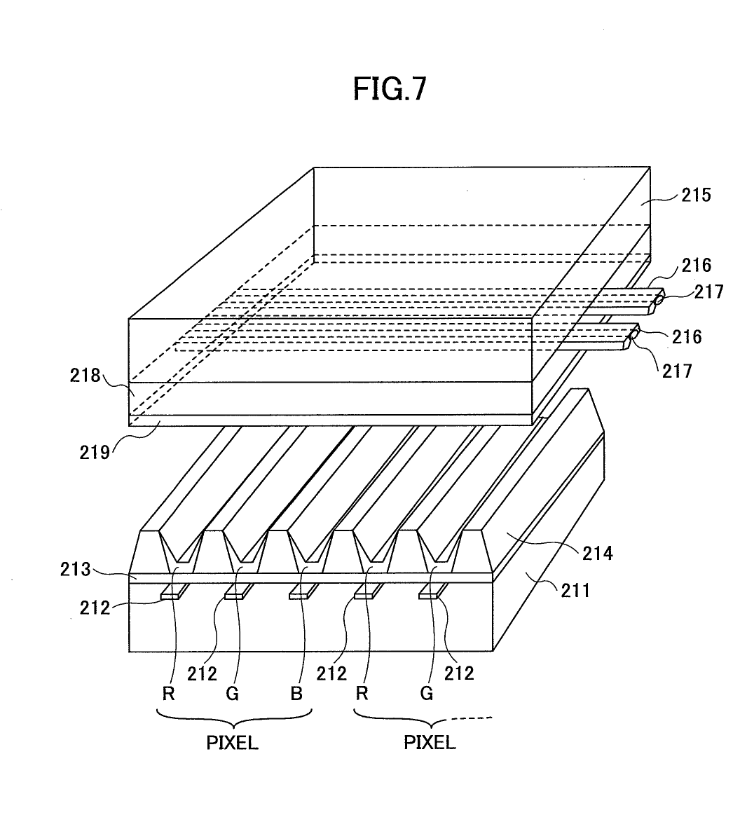

FIG. 7 is a sectional schematic diagram of a three-electrode surface-discharge AC-PDP, to which an embodiment of the present invention is applied. The three-electrode surface-discharge AC-PDP includes two glass substrates, namely, a front glass substrate 215 and a back glass substrate 211. The front glass substrate 215 is provided with BUS electrodes 217 acting as maintenance electrodes and transparent electrodes 216, which function as common maintenance electrodes (X electrodes) and scanning electrodes (Y electrodes), respectively. The X electrodes and the Y electrodes are arranged alternately. A dielectric layer 218 is formed beneath the X electrodes and the Y electrodes, and a protection film 219 made of, for example, MgO, is formed beneath the dielectric layer 218.

The BUS electrodes 217 are highly conductive, and compensate for the insufficient conductivity of the transparent electrodes 216. The dielectric layer 218 maintains discharge by wall charge, and is made of low-melting glass.

Address electrodes 212 are formed on the back glass substrate 211, and are arranged orthogonally with respect to the X electrodes and the Y electrodes. A dielectric layer 213 is formed on the address electrodes 212. Partitions 214 are formed on the dielectric layer 213 at positions corresponding to gaps between the address electrodes 212.

In between the partitions 214, there are fluorescent layers R, G, B formed so as to cover the dielectric layer 213 and the side walls of the partitions 214. The fluorescent layers R, G, B correspond to three colors, i.e., red, green, and blue. When driving the PDP, ultraviolet rays are generated due to discharge between the X electrodes and the Y electrodes. The fluorescent layers R, G, B are excited by the ultraviolet rays so as to emit light and display an image.

Discharge gas fills in between the front glass substrate 215 provided with the X electrodes and the Y electrodes and the back glass substrate 211 provided with the address electrodes 212. Each of the spaces where the X electrodes, the Y electrodes, and the address electrodes 212 cross over each other configure one discharge cell (pixel).

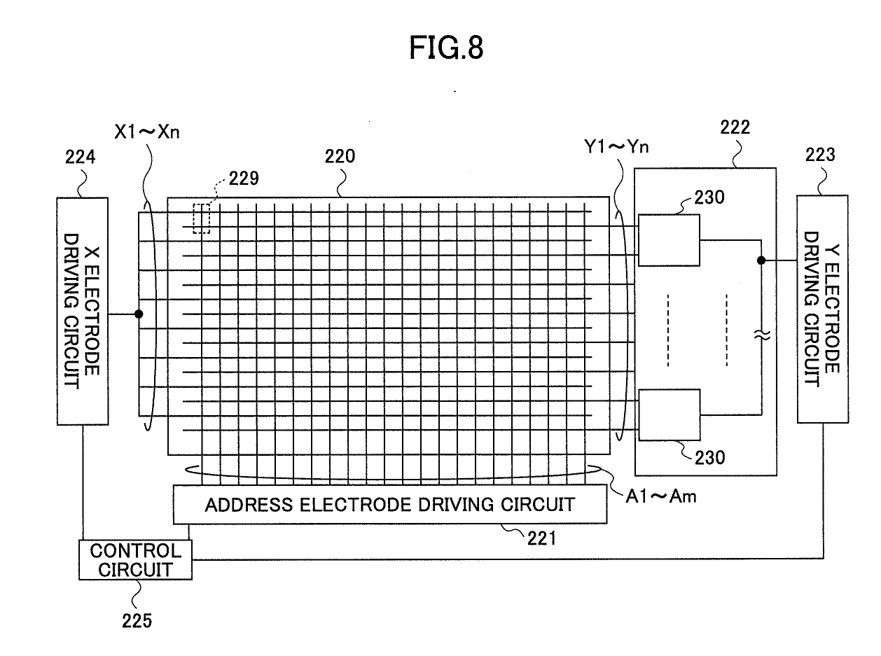

FIG. 8 is a block diagram of relevant parts of a plasma display device. The plasma display device shown in FIG. 8 includes a plasma display panel 220, an address electrode driving circuit 221, a scan driving circuit 222, a Y electrode driving circuit 223, an X electrode driving circuit 224, and a control circuit 225. The scan driving circuit 222 includes plural scan driver ICs 230.

The control circuit 225 generates control signals for controlling the operation of driving the panel in accordance with signals received from outside, such as clock signals, display data, vertical synchronizing pulses, and horizontal synchronizing pulses. Specifically, the control circuit 225 receives display data and loads them in a frame memory, and generates address control signals in accordance with the display data in the frame memory and in synchronization with clocks. The address control signals are supplied to the address electrode driving circuit 221.

The control circuit 225 generates scan driver control signals for controlling the scan driving circuit 222 in synchronization with the vertical synchronizing pulses and the horizontal synchronizing pulses. The control circuit 225 also drives the Y electrode driving circuit 223 and the X electrode driving circuit 224 in synchronization with the vertical synchronizing pulses and the horizontal synchronizing pulses.

The address electrode driving circuit 221 operates in accordance with the address control signals from the control circuit 225 and applies address voltage pulses to address electrodes A1-Am in accordance with the display data. The scan driving circuit 222 operates in accordance with the scan driver control signals from the control circuit 225 and individually drives each of the scan electrodes (Y electrodes) Y1-Yn. The address electrode driving circuit 221 has the configuration shown in FIG. 4.

The scan driving circuit 222 sequentially drives the scan electrodes (Y electrodes) Y1-Yn, while the address electrode driving circuit 221 applies the address voltage pulses on the address electrodes A1-Am, so as to select which cells are to be displayed. Accordingly, cells (pixels) 229 (only one cell is indicated in FIG. 8 as a matter of convenience) are controlled to emit light/not emit light (be selected/not be selected).

The Y electrode driving circuit 223 applies maintenance voltage pulses to the Y electrodes Y1-Yn. The X electrode driving circuit 224 applies maintenance voltage pulses to the X electrodes X1-Xn. By applying maintenance voltage pulses, maintenance discharge occurs between the X electrodes and the Y electrodes at the cells selected as display cells (cells to be displayed).

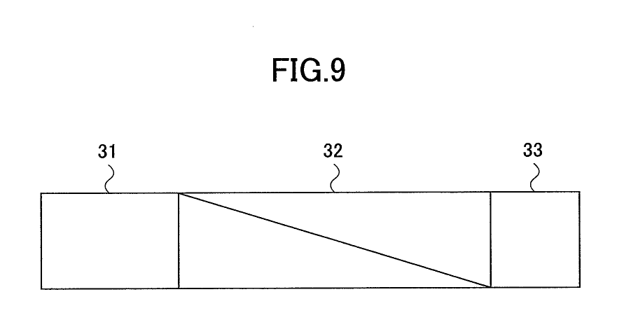

FIG. 9 illustrates an example of a basic operation of the driving circuit shown in FIG. 8. The period during which the PDP is being driven is divided into a reset period 31, an address period 32, and a sustain period 33. The pixels are initialized during the reset period 31, the pixels to be displayed are selected during the address period 32, and finally, the selected pixels are caused to emit light during the sustain period 33.

During the reset period 31, a predetermined voltage waveform is applied to the Y electrodes Y1-Yn acting as scanning electrodes and the common X electrodes X1-Xn, so that all cells are set to an initialized status. That is, cells that previously emitted light and cells that previously did not emit light are initialized so as to be in the same status.

During the address period 32, scanning voltage pulses are sequentially applied to the Y electrodes Y1-Yn acting as scanning electrodes, so as to sequentially scan each of the Y electrodes Y1-Yn one by one. In synchronization with the scanning voltage pulses being applied to the Y electrodes, address voltage pulses are applied to the address electrodes (A1-Am) in accordance with display data. Accordingly, a pixel to be displayed is selected from each of the scanning lines. The diagonal line inside the address period 32 in FIG. 9 indicates a typical scanning timing of the Y electrodes Y1-Yn.

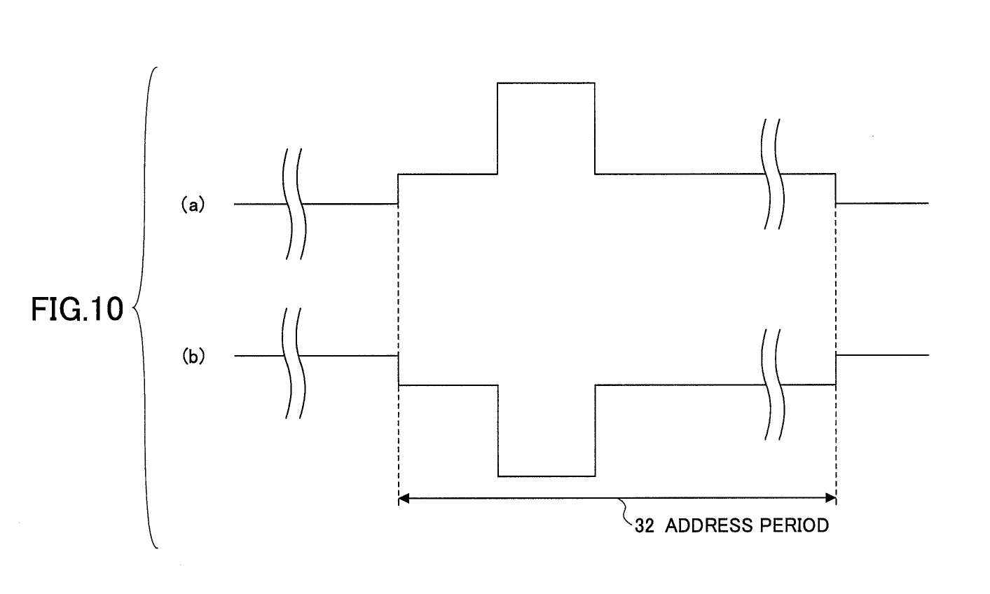

FIG. 10 illustrates a typical address voltage waveform applied to the address electrodes and a typical scanning voltage waveform applied to the Y electrodes. In FIG. 10, (b) denotes a scanning voltage waveform applied to a particular (object) Y electrode during the address period 32. As shown in FIG. 10, the Y electrode receives a negative voltage pulse at a predetermined timing during the address period 32. In synchronization with the scanning driving timings of the Y electrodes, the address electrodes A1-Am receive address voltage pulses in accordance with data.

In FIG. 10, (a) denotes an address voltage waveform applied to a particular (object) address electrode. As shown in FIG. 10, the object address electrode receives a positive address voltage pulse at the same timing as the object Y electrode receives the negative scanning voltage pulse. Therefore, in a cell positioned at the intersection of the object Y electrode and the object address electrode, discharge occurs, a wall charge is formed, and a light emitting status (on status) is selected.

If a positive address voltage pulse were not applied to this object address voltage at any other timing during the address period 32 as indicated by (a) of FIG. 10, only one cell would emit light. Specifically, among the cells along a vertical line corresponding to the object address electrode in the display panel, only one cell, which corresponds to the object Y electrode, would emit light.

Referring back to FIG. 9, in the sustain period 33 following the address period, sustain pulses (maintenance voltage pulses) of the same level are alternately applied to all of the scanning electrodes Y1-Yn and the common X electrodes X1-Xn. Accordingly, sustain pulses are continuously applied to pixels selected to be in the light emitting status (on status) during the address period 32, so that the selected pixels emit light of a predetermined brightness.

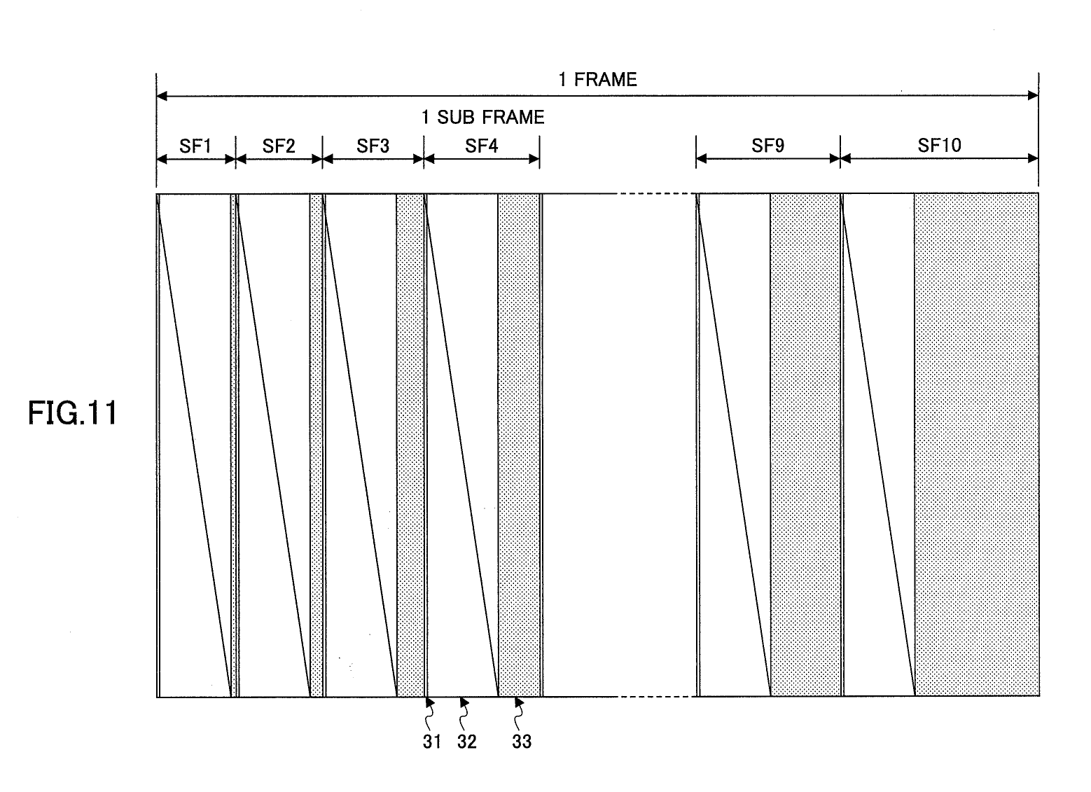

In the plasma display device described above, the cells can only be in two (binary) statuses, i.e., on or off. Accordingly, it is not possible to display gradation shades by controlling the intensity of light emittance. One approach is to control the number of times that each cell emits light. FIG. 11 illustrates a widely applied method of displaying gradation shades by a sub frame method.

FIG. 11 illustrates an example of displaying 1024 gradation shades with ten sub frames. One frame (one display image) is divided into ten sub frames SF1-SF10. Each of the sub frames SF1-SF10 includes the reset period 31, the address period 32, and the sustain period 33. The different sub frames operate in substantially the same manner in the reset periods 31 and the address periods 32. However, during the sustain periods 33, different numbers of sustain pulses are specified for the different sub frames. According to the combination of these sub frames having different numbers of sustain pulses, gradation shades can be displayed arbitrarily.

There are various methods of allocating the numbers of sustain pulses to the ten sub frames. Generally, the numbers of sustain pulses of the ten sub frames are specified to satisfy 2⁰=1, 2¹=2, 2²=4, . . . , 2⁹=512. By emitting light with arbitrary combinations of sub frames selected from the ten sub frames, it is possible to display a maximum of 1024 gradation shades.

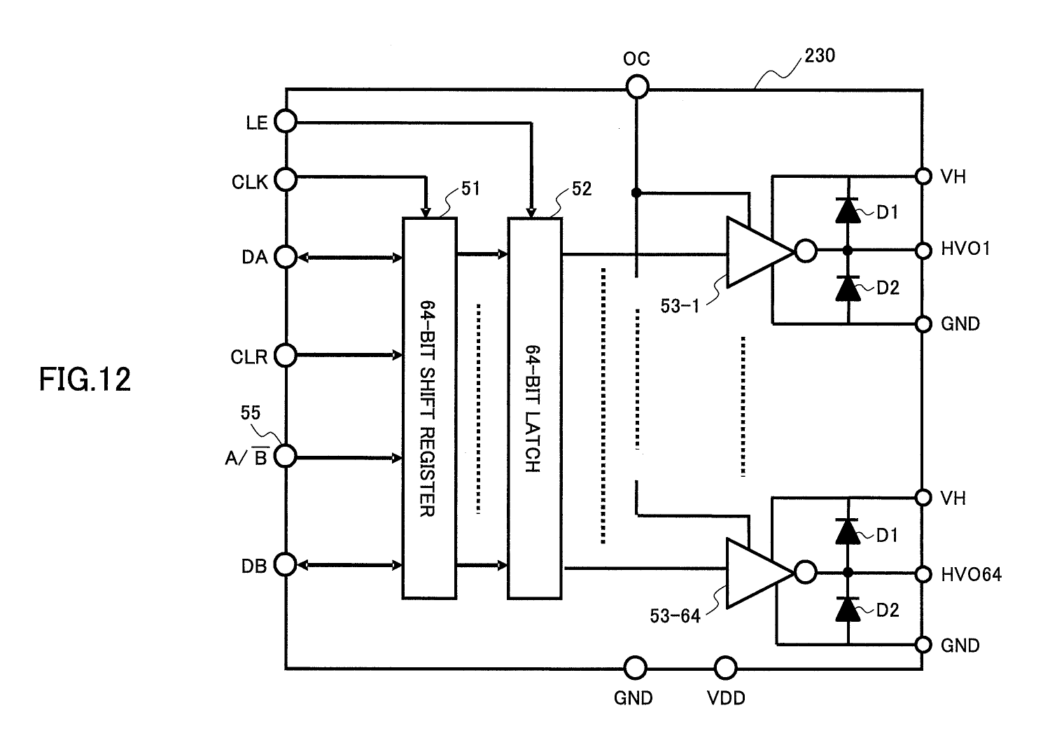

FIG. 12 is a circuit diagram of an example of the scan driver IC 230. The scan driver IC 230 shown in FIG. 12 includes a 64-bit shift register 51, a 64-bit latch 52, output drivers 53-1-53-64, and diodes D1, D2 provided for each of the output drivers 53-1-53-64.

Power supply terminals VH and GND of the scan driver IC 230 are connected to the Y electrode driving circuit 223. Output control signals OC are supplied from the Y electrode driving circuit 223. In the Y electrode driving circuit 223, a capacitor is provided to absorb voltage variations, and therefore, the voltage of the power supply terminal VH is maintained at a substantially constant voltage with respect to the voltage of the power supply terminal GND.

GND represents the ground potential of the scan driver IC 230. However, as it is obvious from the description below, GND is not fixed to ground potential and changes according to the operation. The constant voltage between the power supply terminals VH and GND is a high voltage of substantially 50 V or more.

The 64-bit shift register 51 receives input data DA indicating scanning driving timings of the Y electrodes, and sequentially shifts the data DA in synchronization with clock signals CLK. The 64-bit latch 52 latches the output of 64 bits from the 64-bit shift register 51 in response to latch enable signals LE. The output drivers 53-1-53-64 output driving signals according to whether the 64 outputs from the 64-bit latch 52 are HIGH/LOW.

The data DA indicating scanning driving timings of the Y electrodes are output outside the scan driver IC 230 as the data DB after propagating through the inside of the 64-bit shift register 51. These data DB are input as input data DA in the 64-bit shift register 51 of the scan driver IC 230 of a next stage.

Outputs HVO1-HVO64 from the corresponding 64 output drivers 53-1-53-64 are connected to 64 Y electrodes. The output drivers 53-1-53-64 change over the statuses of the outputs HVO1-HVO64 according to output control signals OC. For example, when the output control signal OC is HIGH, the output drivers 53-1-53-64 generate voltages according to whether the 64 outputs of the 64-bit latch 52 are HIGH/LOW, and output the generated voltages as the outputs HVO1-HVO64. When the output control signal OC is LOW, the output drivers 53-1-53-64 specify the outputs HVO1-HVO64 as high impedance (Hi-Z) statuses.

Specifically, the outputs HVO1-HVO64 from the output drivers 53-1-53-64 become Hi-Z during the sustain period 33 and become voltages according to whether the 64 outputs of the 64-bit latch 52 are HIGH/LOW during the address period 32.

During the sustain period 33, positive/negative sustain voltages Vs are alternately supplied from the Y electrode driving circuit 223 to the power supply terminal GND, and sustain pulses are applied to the Y electrodes via the output drivers 53-1-53-64 and the corresponding diodes D1 and D2. When a current is flowing from the Y electrode driving circuit 223 toward the Y electrodes, it flows through the diodes D2. When a current is flowing from the Y electrodes toward the Y electrode driving circuit 223, it flows through the diodes D1 and the output drivers 53-1-53-64.

During the address period 32, a negative scanning voltage is supplied from the Y electrode driving circuit 223 to the power supply terminal GND. As the address period 32 starts, the output control signals OC are HIGH, the output drivers 53-1-53-64 are activated, and the Y electrodes are made to have voltages supplied from the power supply terminal VH. Subsequently, while the output control signals OC are maintained at a HIGH level, according to the data DA that are sequentially propagated to the 64-bit shift register 51, the output drivers 53-1-53-64 sequentially drive the Y electrodes one by one. Specifically, the Y electrodes are driven by scanning voltage pulses according to negative scanning voltages supplied to the power supply terminal GND. When the address period 32 ends, the output control signals OC become LOW and the output drivers 53-1-53-64 stop operating.

The present invention is not limited to the specifically disclosed embodiment, and variations and modifications may be made without departing from the scope of the present invention.

The present application is based on Japanese Priority Patent Application No. 2006-247127, filed on Sep. 12, 2006, the entire contents of which are hereby incorporated by reference.

What is claimed is:

1. A plasma display device provided with a capacitive load driving circuit configured to drive a capacitive load, wherein
a first terminal of the capacitive load is connected to an output terminal of the capacitive load driving circuit, and a driver power supply is connected through a series connection of a power distributing unit and a driver element to the output terminal of the capacitive load driving circuit, and
a diode being connected in parallel to the power distributing unit.

2. The plasma display device according to claim 1, wherein
the driver element is an n channel MOS transistor.

3. The plasma display device according to claim 2, wherein
the power distributing unit is a resistance element having an impedance that is one tenth or more of a resistance component of an impedance of the driver element during conduction.

4. The plasma display device according to claim 1, wherein
the capacitive load driving circuit corresponds to an address electrode driving circuit,
the first terminal of the capacitive load corresponds to an address electrode, and
a second terminal of the capacitive load corresponds to an X electrode and a Y electrode.

5. The plasma display device according to claim 1, wherein
plural driver elements corresponding to plural capacitive loads are integrated in the capacitive load driving circuit.
